(19) United States
(12) Patent Application Publication
(10) Pub. No.: US 2008/0013961 A1
(43) Pub. Date: Jan. 17, 2008

(54) MINIATURE COMPOSITE ASSEMBLY THAT INCORPORATES MULTIPLE DEVICES THAT USE DIFFERENT WAVELENGTHS OF LIGHT AND METHOD FOR MAKING THE COMPOSITE ASSEMBLY

(76) Inventors: Pak Hong YEE, Singapore (SG); Peng Yam Ng, Singapore (SG); Wee Sin Tan, Singapore (SG)

Correspondence Address: Kathy Manke;Avago Technologies Limited, 4380 Ziegler Road, Fort Collins, CO, 80525, US

(21) Appl. No.: 11/552,008

(22) Filed: Oct. 23, 2006

(30) Foreign Application Priority Data
Jul. 13, 2006 (SG) 200604731-0

(51) Int. Cl. H04B 10/00

(52) U.S. Cl. 398/164

(57) ABSTRACT

A remote control (RC) receiver device and an ambient light photosensor (ALPS) device are mounted on a single mounting device (e.g., printed circuit board) such that they are part of a single composite assembly. This reduces the amount of space that is needed in electronic devices that incorporate both RC receiver devices and ALPS devices. In addition, by implementing both devices in a single composite assembly, costs associated with manufacturing, assembly and shipping can be reduced. Because the RC receiver device and the ALPS device operate on light of different wavelengths, the composite assembly includes filtering mechanisms that prevent undesired wavelengths of light from impinging on the photodiode of the RC receiver device and on the photosensor of the ALPS device.

### CROSS REFERENCE TO RELATED APPLICATIONS

This application claims priority to Singapore Patent Application No. 200604731-0, filed Jul. 13, 2006, which is incorporated herein by reference in its entirety.

### TECHNICAL FIELD OF THE INVENTION

The invention relates to devices that receive optical energy and convert it into electrical energy.

### BACKGROUND OF THE INVENTION

It is becoming increasingly common for consumer electronic devices to incorporate devices that use different wavelengths of light. Remote control (RC) receiver devices and ambient light photosensor (ALPS) devices are examples of devices that use different wavelengths of light and that are commonly incorporated into the same consumer electronic device. RC receiver devices and ALPS devices are used in a wide variety of electronic devices, such as television sets (TVs), digital video disc (DVD) players, personal computers (PCs), laptop computers, notebook PCs, and other types of devices.

RC receiver devices receive electromagnetic signals that are transmitted over an air interface from an RC transmitter device operated by a user. The electromagnetic signals are typically infrared (IR) signals. A photodiode of the RC receiver produces electrical signals in response to receiving the electromagnetic signals transmitted by the RC transmitter device. The electrical signals produced by the photodiode are converted into digital signals, which are then processed by the IC of the RC receiver device. The IC produces an output signal that is used by the electronic device in which the RC receiver device is employed (e.g., a laptop computer) to cause the electronic device to perform some function (e.g., run a particular application software program).

The RC receiver device is typically mounted on a circuit board and connections are made between conductors of the circuit board and the input/output (I/O) pads of the IC of the RC receiver device. The circuit board having the RC receiver device mounted on it is then installed in the electronic device and electrical connections are made between the I/O ports of the circuit board and devices or components of the electronic device.

ALPS devices are also employed in other systems, such as home lighting systems and wireless handheld devices such as personal digital assistants (PDAs) and mobile telephones. ALPS devices sense the level of ambient light in the surroundings and adjust brightness so that the lighting level is not too bright or too dark given the current level of ambient light in the surroundings. ALPS devices typically include an IC having an ambient light photosensor on it that senses the level of ambient light in the surroundings and produces an electrical signal that is converted into a digital signal for processing by the IC of the ALPS device. The IC produces an output signal that is used by the electronic device in which the ALPS device is employed to cause the electronic device to perform some function (e.g., adjust the brightness level of the TV screen or PC display monitor).

An ALPS device is typically mounted on a circuit board and connections are made between conductors of the circuit board and the I/O pads of the ALPS IC. The circuit board having the IC mounted on it is then installed in the electronic device and electrical connections are made between the I/O ports of the circuit board and components or device of the electronic device.

Electronic devices that employ both RC receiver devices and ALPS devices include one circuit board that has the RC receiver device mounted on it and another circuit board that has the ALPS device mounted on it. Each circuit board consumes a significant amount of space in the electronic device. Of course, a major goal in manufacturing many consumer electronic devices is to reduce their size. To achieve this goal, manufacturers are constantly searching for ways to efficiently use the available space. However, the number and types of functions that many electronic devices perform continue to increase, which makes it ever increasingly difficult to achieve overall size reduction. Using separate circuit boards for the RC receiver device and the ALPS device results in a relatively large amount of space in an electronic device being consumed, and also increases overall costs.

It would be desirable to provide a way to implement an RC receiver device and an ALPS device in a single composite assembly in order to conserve space in an electronic device that employs both devices. In addition, implementing an RC receiver device and an ALPS device into a single composite assembly should reduce costs associated with manufacturing, assembling and shipping the devices.

However, implementing both an RC receiver device and an ALPS device in a single composite assembly presents challenges. The photodiode of the RC receiver device is intended to receive IR light, but should be shielded from other wavelengths of light. Similarly, the photosensor of the ALPS device is intended to receive visible light from the surroundings, but should be shielded from light of other wavelengths that may come from the surroundings.

Accordingly, a need exists for a suitable way to incorporate devices that use different wavelengths of light, such as an RC receiver device and an ALPS device, into a single composite assembly.

### SUMMARY OF THE INVENTION

The invention provides a miniaturized composite assembly having multiple devices that operate on different wavelengths of light, and a method for making the assembly. The assembly comprises a mounting device, a first receiver device mounted on the mounting device that operates on a first set of wavelengths of light, a second receiver device mounted on the mounting device that operates on a second set of wavelengths of light, a first filter device located on the first receiver device, and a second filter device located on the second receiver device. The first set of wavelengths are different from the second set of wavelengths. The first receiver device has electrical connections that are connected to conductors of the mounting device. The second receiver device has electrical connections that are connected to conductors of the mounting device. The first filter device passes light of the first set of wavelengths and filters out light of other wavelengths such that only light of the first set of wavelengths passes through the first filter device and impinges on the first receiver device. The second filter device passes light of the second set of wavelengths and filters out light of other wavelengths such that only light of the second set of wavelengths impinges on the second receiver device.

The method for making the assembly comprises mounting a first IC that operates on a first set of wavelengths on the mounting device, mounting a second IC that operates on a second set of wavelengths on the mounting device, performing a wire-bonding process to bond conductors of the first and second ICs to conductors of the mounting device, and applying a transparent epoxy over the assembly such that the first and second ICs and the first and second filter devices are covered by the transparent epoxy. The first IC has a first filter device disposed thereon that passes light of the first set of wavelengths and filters out light of other wavelengths such that only light of the first set of wavelengths impinges on the first IC. The second IC has a second filter device disposed thereon that passes light of the second set of wavelengths and filters out light of other wavelengths such that only light of the second set of wavelengths impinges on the second IC.

These and other features and advantages of the invention will become apparent from the following description, drawings and claims.

### BRIEF DESCRIPTION OF THE DRAWINGS

FIG. 1 illustrates a block diagram of the composite assembly of the invention in accordance with the exemplary embodiment, which includes an RC receiver device and an ALPS device mounted on and electrically connected to a mounting device.

FIG. 2 illustrates a cross-sectional view of the composite assembly shown in FIG. 1.

FIG. 3 illustrates a flowchart that represents the exemplary method described above with reference to FIG. 2.

FIGS. 4A and 4B illustrate top and side views, respectively, of the composite assembly 1 shown in FIG. 2 after assembly has been completed.

### DETAILED DESCRIPTION OF AN EXEMPLARY EMBODIMENT

In accordance with the invention, an RC receiver device and an ALPS device are mounted on a single mounting device such that they are part of a single composite assembly. This reduces the amount of space that is needed in electronic devices that incorporate both RC receiver devices and ALPS devices. In addition, by implementing both devices in a single composite assembly, costs associated with manufacturing, assembly and shipping can be reduced. Because the RC receiver device and the ALPS device operate on light of different wavelengths, the composite assembly includes filtering mechanisms that prevent undesired wavelengths of light from impinging on the photodiode of the RC receiver device and on the photosensor of the ALPS device.

It should be noted, however, that the invention applies to devices other than RC receiver devices and ALPS devices. RC receiver devices and ALPS devices are merely examples of two types of devices that operate at different wavelengths of light and that would be advantageous to implement in a single composite assembly. Therefore, for exemplary purposes, the principles and concepts of the invention will be described with reference to incorporating an RC receiver device and an ALPS device into a single composite assembly. Those skilled in the art will understand the manner in which these principles may be applied to other types of devices that operate at different wavelengths of light. Also, the invention is not limited with respect to the number of such devices that may be incorporated into a single composite assembly.

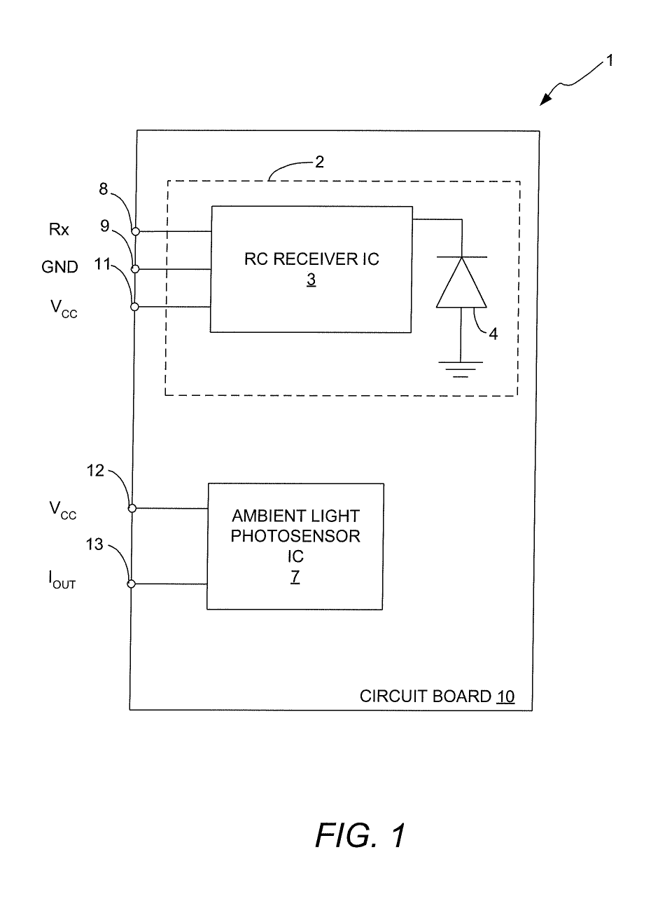

FIG. 1 illustrates a block diagram of the composite assembly 1 of the invention in accordance with the exemplary embodiment, which includes an RC receiver device 2 and an ALPS device 6. The composite assembly 1 includes a mounting device 10, which is typically a printed circuit board (PCB). The RC receiver device 2 and the ALPS device 6 are mounted on the mounting device 10. The RC receiver device 2 includes an IC package 3 and an IR photodiode 4. The IR photodiode 4 is represented symbolically, but it is actually a separate IC. The ALPS device 7 comprises an IC, which includes an ambient light photosensor (not shown). The RC receiver device 2 and the ambient light sensor device 7 may be known devices that are currently available on the market.

The junctions labeled 8, 9 and 11-13 are the ports of the mounting device 10. The port 8 is an output port that receives the receiver signal, Rx, that is output at a pin (not shown) of the RC receiver IC 3 and sent over a conductive trace and wire bonds to the port 8. The port 9 is an input port of the mounting device 10 that is used to supply ground potential, GND, to a pin (not shown) of the RC receiver IC 3. The port 11 is an input port of the mounting device 10 that is used to supply the supply voltage, Vcc, to a pin (not shown) of the RC receiver IC 3. The port 12 is an input port of the mounting device 10 that is used to provide the supply voltage, Vcc, to a pin (not shown) of the IC of the ALPS device 7. The port 13 is an output port of the mounting device 10 that receives the ALPS signal, IOUT, that is output at a pin (not shown) of the ALPS device IC 7. The RC receiver photodiode IC 4 has a pin (not shown) that is electrically connected to a pin (not shown) of the RC receiver IC 3.

The receiver signal Rx and the ALPS signal IOUT received at ports 8 and 13, respectively, of the mounting device 10 are provided to other devices or components within the electronic device (not shown). These other devices or components use the signals in a known manner, e.g., to cause an application program to be executed by a processor, to cause the brightness of a display monitor to be adjusted, etc.

For purposes of describing an example of the manner in which the composite assembly of the invention may be implemented, the assembly is being described as having three separate ICs, namely, the RC receiver IC 3, the RC receiver photodiode IC 4 and the ALPS IC 7. This is because these devices are currently available on the market as three separate ICs. However, all of these devices may be integrated in the same IC or in two separate ICs. For example, the RC receiver IC 3 and the RC receiver photodiode IC 4 may be integrated into one IC and the ALPS device 7 may be implemented in a separate IC. Integrating more devices into the same IC or into two ICs enables the composite assembly to be further reduced in size and provides further cost savings.

The composite assembly 1 consumes much less space when installed in an electronic device than that which is consumed when an RC receiver device and an ALPS device are mounted on respective circuit boards and installed in an electronic device. Thus, the invention enables electronic devices to be made smaller in size and/or to include additional devices that provide additional functions to the electronic device. In addition, the costs associated with manufacturing, assembly and shipping the composite assembly can be less than those associated with separate assemblies.

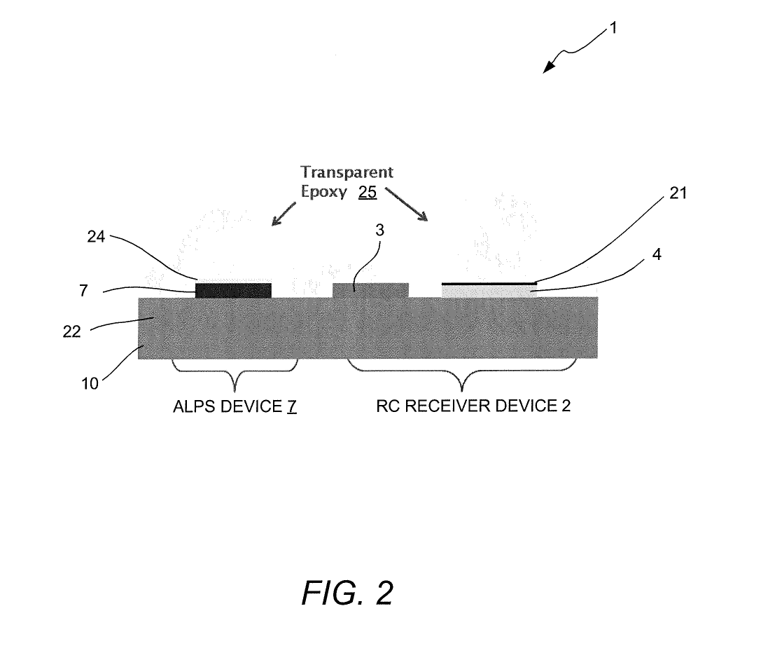

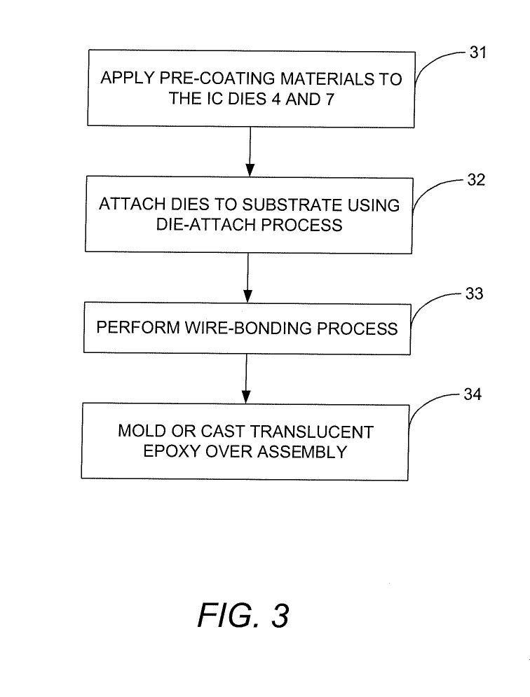

The method of the invention for making the composite assembly 1 shown in FIG. 1 will now be described with reference to FIGS. 2 and 3. FIG. 2 illustrates a cross-sectional view of the composite assembly 1 shown in FIG. 1. The RC receiver IC 3, the RC receiver photodiode IC 4 and the ALPS IC 7 are attached to the mounting device 10 using a known die-attach process. However, prior to attaching the ICs 3, 4 and 7, the ICs 4 and 7 are pre-coated with coatings 21 and 24, respectively. The coatings 21 and 24 comprise materials that are capable of filtering out undesired wavelengths of light. The coating 21 allows IR light to pass through it and impinge on the RC photodiode IC 4, but filters out all other wavelengths of light. The coating 24 allows visible portions of the ambient light to pass through it, but filters out other wavelengths of light. Thus, only visible light will pass through the coating 24 and impinge on the ALPS photosensor IC 7. A variety of IR and visible-light coating materials are currently available that are suitable for this purpose.

After the ICs 3, 4 and 7 have been attached, a wire-bonding process is performed to make all of the electrical connections between the pins of the ICs 3, 4 and 7 and conductors (not shown) of the mounting device 10. The manner in which wire bonding is performed is well known. The upper surface of the assembly 1 is then covered with a transparent epoxy 25. The transparent epoxy 25 may be applied using, for example, a transfer molding process or a sheet cast molding process. The transparent epoxy 25 allows ambient light to penetrate through it, which includes IR light. However, the visible-light coating 24 only allows visible light to pass through it and impinge on the ALPS IC 7. The process steps that are performed after the transparent epoxy has been applied are the normal process steps used when assembling a circuit board today. Therefore, these process steps will not be described.

FIG. 3 illustrates a flowchart that represents the exemplary method described above with reference to FIG. 2. The ICs 4 and 7 are pre-coated with the coating materials 21 and 24, respectively, as indicated by block 31. The pre-coating process is typically performed at the wafer level. The ICs 3, 4 and 7 are attached using a die-attach process, as indicated by block 32. Intermediate process steps may be performed after pre-coating the ICs 4 and 7 and before attaching the ICs 3, 4 and 7. After the ICs have been attached, they are wire bonded to the conductors of the mounting device, as indicated by block 33. After wire bonding has been performed, the transparent epoxy 25 is applied by a molding or casting process, as indicated by block 34. As stated above, other known process steps are typically performed after the transparent epoxy has been applied.

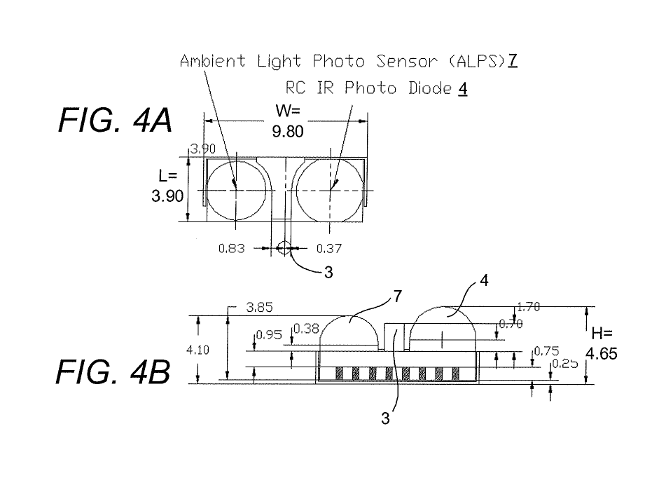

FIGS. 4A and 4B illustrate top and side views, respectively, of the composite assembly 1 after assembly has been completed. The invention is not limited to the dimensions shown. The dimensions are provided to demonstrate an example of the miniature nature of the assembly. The dimensions shown are in units of millimeters (mm). In FIG. 4A, it can be seen that the overall width, W, of the assembly 1 is 9.80 mm. It can also be seen in FIG. 4A that the overall length, L, is 3.90 mm. It can be seen in FIG. 4B that the overall height, H, is 4.65 mm or less. Thus, the composite assembly 1 is extremely small in size and will consume only a very small amount of space in the electronic device in which it is employed.

The invention has been described with reference to exemplary embodiments for the purpose of demonstrating the principles and concepts of the invention. As will be understood by those skilled in the art, many modifications may be made to the embodiments described herein and all such modifications are within the scope of the invention.

What is claimed is:

1. A composite assembly comprising:
a mounting device;
a first receiver device mounted on the mounting device, the first receiver device operating on a first set of wavelengths of light, the first receiver device having electrical connections that are connected to conductors of the mounting device;
a second receiver device mounted on the mounting device, the second receiver device operating on a second set of wavelengths of light, the second receiver device having electrical connections that are connected to conductors of the mounting device;
a first filter device located on the first receiver device, the first filter device passing light of the first set of wavelengths and filtering out light of other wavelengths such that only light of the first set of wavelengths passes through the first filter device and impinges on the first receiver device; and
a second filter device located on the second receiver device, the second filter device passing light of the second set of wavelengths and filtering out light of other wavelengths such that only light of the second set of wavelengths impinges on the second receiver device.

2. The composite assembly of claim 1, wherein the first receiver device includes an infrared (IR) photodiode integrated circuit (IC), the first set of wavelengths comprising IR wavelengths.

3. The composite assembly of claim 2, wherein the first filter device is an IR coating disposed on the first receiver device.

4. The composite assembly of claim 1, wherein said second receiver device includes an ambient light photosensor (ALPS) integrated circuit (IC), and wherein the second set of wavelengths comprises wavelengths of visible light, and wherein the second filter device is a visible light pass filter, the visible light pass filter comprising a coating, and wherein only visible light passes through the coating and impinges on the ALPS IC.

5. The composite assembly of claim 4, further comprising:
a transparent epoxy that covers the first and second receiver devices and the first and second filter devices.

6. The composite assembly of claim 4, wherein the composite assembly is less than approximately 10 millimeters (mm) in width, 4 mm in length and 5 mm in height.

7. A method for making a composite assembly that includes multiple devices that operate at different wavelengths, the method comprising:
mounting a first integrated circuit (IC) to mounting device, the first IC operating on a first set of wavelengths of light, the first IC having a first filter device disposed thereon, the first filter device passing light of the first set of wavelengths and filtering out light of other wavelengths such that only light of the first set of wavelengths impinges on the first IC; and
mounting a second IC to the mounting device, the second IC operating on a second set of wavelengths of light, the second IC having a second filter device disposed thereon, the second filter device passing light of the second set of wavelengths and filtering out light of other wavelengths such that only light of the second set of wavelengths impinges on the second IC, wherein the wavelengths of the first set of wavelengths are different from the wavelengths of the second set of wavelengths;
performing a wire-bonding process to bond conductors of the first and second ICs to conductors of the mounting device;
applying a transparent epoxy over the assembly such that the first and second ICs and the first and second filter devices are covered by the transparent epoxy.

8. The method of claim 7, wherein the first IC is an infrared (IR) photodiode IC, the first set of wavelengths comprising IR wavelengths.

9. The method of claim 7, wherein the first filter device is an IR coating that is applied to the first IC prior to the first IC being attached to the mounting device.

10. The method of claim 7, wherein the second IC is an ambient light photosensor (ALPS) IC, and wherein the light of the second set of wavelengths is visible light, and wherein the second filter device is a coating that is applied to the second IC prior to the second IC being mounted on the mounting device, and wherein the coating on the second IC passes visible light and blocks other wavelengths of light such that only visible light impinges on the ALPS IC.

11. The method of claim 7, wherein the composite assembly is less than approximately 10 millimeters (mm) in width, 4 mm in length and 5 mm in height.

12. The method of claim 17, wherein the first IC is an IR photodiode IC of a remote control (RC) receiver device, and the second IC is an ambient light photosensor (ALPS) IC of an ALPS device.
